(19) United States
(12) Patent Application Publication
(10) Pub. No.: US 2011/0163048 A1
(43) Pub. Date: Jul. 7, 2011

(54) A METHOD AND A DEVICE FOR CLEANING OF SO-CALLED WASTE OIL

(76) Inventor: Claes Olofsson, Kalmar (SE)

(21) Appl. No.: 13/063,239

(22) PCT Filed: Sep. 11, 2009
(86) PCT No.: PCT/SE09/00406

§ 371 Date: Mar. 10, 2011

(30) Foreign Application Priority Data
Sep. 11, 2008 (SE) 0801965-5

(51) Int. Cl. B01D 17/025; B01D 17/032

(52) U.S. Cl. 210/774; 210/177; 210/97

(57) ABSTRACT

The present disclosure relates to a method and a device, in the form of an oil separator, for cleaning so-called waste oil, which contains oil and water, wherein the cleaned oil is so clean that it can be re-used. The oil separator (1) includes a first separation tank (3) for approx. 80% separation of waste oil fed in from a suction pump (2), a second separation tank (5) including a water filter (8) with a partition (6) containing return water fed in from the first separation tank (3) on one side, and fed in clean, temperature-regulated water (12) on the other side, which forces the oil in the residual water up to the top of the tank (5), from which point the residual oil can be conveyed, via a pipe (9), to a heating tank (4), where this oil, together with the waste oil from the first tank (3), already approx. 80% cleaned, can be heated to approx. 90° C. before the oil is fed to a subsequent collection tank (7), and a filter (11) connected to it, for final cleaning of the separated oil before re-use. Moreover, both separation tanks (3, 5) incorporate sensors (30) for keeping the water level in them constant at all times.

The present invention relates to a method for cleaning so-called waste oil, which contains oil, water and metal particles, in which the cleaned oil is so clean that it can be re-used, and an oil separator for carrying out the method mentioned.

One object of the present invention is to provide a method and a device in the form of an oil separator for carrying out the method, which fulfils its object in an excellent manner whilst at the same time the oil separator itself represents a profitable investment for any shipowner and which solves previous problems relating to the handling of waste oil.

Thanks to the invention a simple, low cost solution to the above-mentioned problem has been provided. The device according to the invention cleans the waste oil to a very high level, and the waste oil can therefore be re-used on board in an incinerator or water boiler without any operational problems. If the owner decides to send the waste oil to a shore installation, the waste oil may be considered as clean slurry oil. The quantity of waste oil abroad is reduced, which in effect will minimise the total cost of this handling of the waste oil. The water content and particle size exceeding 10 microns are reduced to a minimum, and this provides the engine crew on board with greater flexibility in handling the waste oil. Due to the invention the separator capacity is one cubic metre per hour and slurry treatment is therefore minimised on board to approximately one hour per day. Waste oil containing oil, water and metal particles can be separated with this oil separator entirely without chemicals and the oil can then be re-used because it is not mixed with chemicals.

The invention is described more in detail below with reference to the following drawings, in which

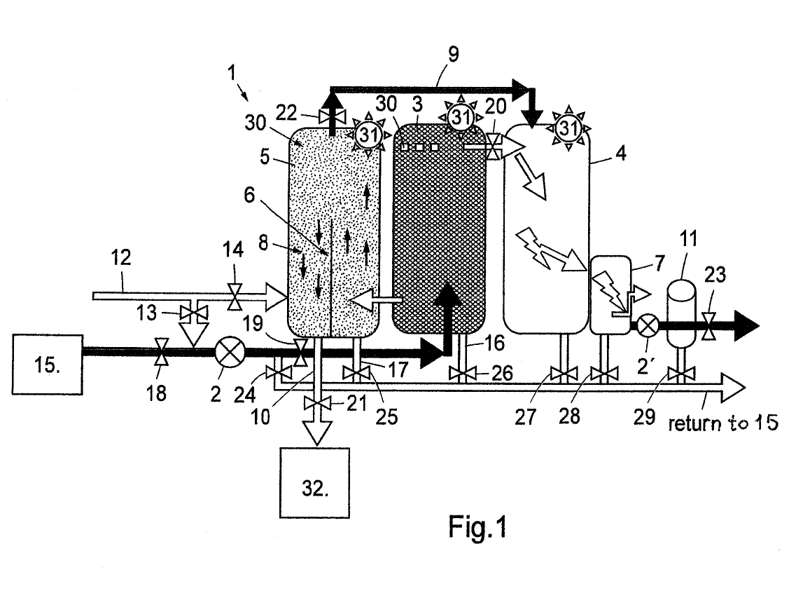

FIG. 1 shows a schematic view of the units that constitute the oil separator, and

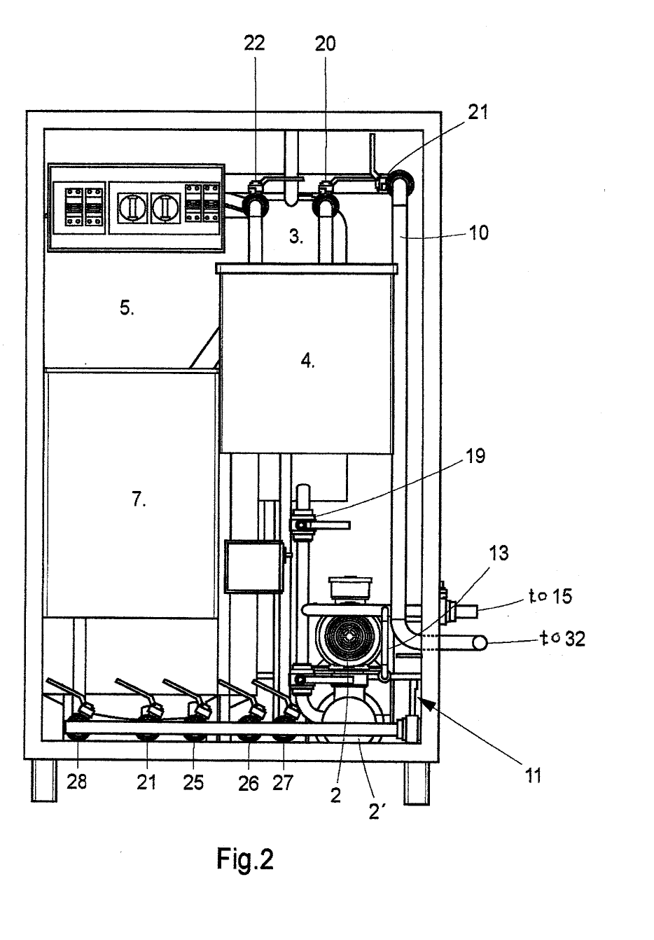

FIG. 2 shows a schematic front view of the oil separator.

As shown in FIG. 1, the operation of oil separator 1 according to a preferred embodiment of the invention is as follows:

In a first step waste oil is sucked up by a suction pump 2 from a slurry oil tank 15, and its temperature is adjustable from approximately 10° C. to 15-20° C. by means of clean water 12 supplied via a valve 13. The waste oil is then fed on in this first step into a first separation tank 3, where it is approx. 80% separated, from which point the oil in the very top of tank 3 is fed into an adjacent heating tank 4, where it is heated to approx. 90° C. by electricity or steam in spiral tubes, whereupon the oil flows across to a collection tank 7, from which the oil is pumped by means of a pump 2′ through a filter 11, where the oil is filtered before pumping out for re-use and the thickest slurry is then fed out via an outlet 16 back to slurry oil tank 15. In a second step return water and particles in the oil at the bottom of first tank 3 during the first step are fed into a second separation tank 5 containing a water filter 8 with a partition 6, which, on one side of it separates the return water from the remaining waste oil from tank 3 by pumping tempered clean water 12 in on the other side of partition 6, forcing up the oil to the top of tank 5, where residual oil is fed across via a pipe 9 to the heating tank 4 at the same time as residual water is pumped out via an outlet 10 from the other side of second separation tank 5 to a collection tank 32, whilst the thickest slurry is fed out of the second tank 5 via an outlet 17 to the slurry oil tank 15. By supplying clean water 12 in this second step it is possible not only to maintain the level on water filter 8 with the clean water, but also to control the temperature by means of thermometers 31 in all tanks 3-5 at approx. 18° C. for the best efficiency, which means that the oil is separated more easily whilst the partition 6 prevents the oil from being forced down onto the return water. The water level in both separation tanks 3 and 5 can always be kept constant by means of sensors 30 and by adjusting the oil separation via a valve 18 in the first step this operation maintains a closed circuit or path inside the vessel for separating oil or cleaning the oil without any chemical additives or substances.

The device, in the form of an oil separator 1, which is also shown schematically in FIG. 2, according to a preferred embodiment of the invention for carrying out a method for cleaning so-called waste oil, comprises a first separation tank 3 for approx. 80% separation of waste oil fed in from a suction pump 2, a second separation tank 5 comprising a water filter 8 with a partition 6 containing return water fed in from the first separation tank 3 on one side, and fed-in clean, temperature-regulating water 12 on the other side, which forces the oil in the residual water up to the top of tank 5, from which point the residual oil can be conveyed via a pipe 9 to a heating tank 4, where this oil, together with the waste oil from first tank 3 already approx. 80% cleaned, can be heated to approx. 90° C. before the oil is fed to a subsequent collection tank 7, and a filter 11 connected to that tank for final cleaning of the oil fed to an oil tank 33 and separated before re-use. Moreover, both separation tanks 3 and 5 incorporate sensors for keeping the water level in them constant at all times.

The fed-in clean water 12, which can be temperature-regulated, can be fed in via the first-mentioned valve 13 for supply to the waste oil for regulating its temperature to preferably approx. 18° C., and via a second valve 14 for feeding into the water filter 8 for keeping it full.

For operating the separator there are also a number of other valves 18-29, which are regulated as follows: First valves 18, 19 and 20 are opened, valve 20 of which is opened to discharge excess pressure and oil. Valve 21 for outlet 10 regulates the oil discharge via valve 20. Valve 22 is opened occasionally to discharge residual oil in the process. Valves 13 and 14 are used, as mentioned above, to keep the water filter 8 full and regulate the temperature in the process via the suction pump 2. Valve 23 regulates the discharge to oil tank 33 and valves 24-29 are used to drain the system and discharge residual water to slurry oil tank 15.

1. A method for cleaning of so-called waste oil, which contains oil and water, wherein the cleaned oil can then be re-used, wherein the waste oil is in a first step sucked up by means of a suction pump from a slurry oil tank to a first separation tank, where it is approx. 80% separated, and where the oil that is at the very top of the tank is fed on to a heating tank, where it is heated to approx. 90° C., and where cleaned oil is then fed to a collection tank, from which the oil is filtered before being pumped out to a tank for re-use, in that in a second step return water from the first step is fed from the first separation tank to one side of a partition in a water filter comprising a second separation tank, which filter separates the return water from the residual waste oil by means of the aforementioned partition on one side of it, by pumping in tempered clean water on the other side of the partition and forcing up the oil to the top of the tank, where residual oil is fed across via a pipe to the heating tank, whilst residual water is pumped out via an outlet from the other side of the partition in the separation tank, and in that the water level in both separation tanks is kept constant by means of sensors, wherein oil inside a vessel, for example, is separated without the use of any chemical substance.

2. A method according to claim 1, wherein the sucked up waste oil is regulated with a temperature of approx. 10° C. during the first and second steps to preferably 18° C. by means of the clean water fed into it, whilst the clean water, at the same temperature, is also pumped directly into the water filter.

3. A device for carrying out a method for cleaning so-called waste oil which contains oil and water, wherein the cleaned oil can then be re-used, and wherein it comprises a first separation tank for approx. 80% separation of waste oil fed in from a suction pump, a second separation tank comprising a water filter with a partition containing return water fed in from the first separation tank on one side, and fed in clean, temperature-regulated water on the other side, which forces the oil in the residual water up to the top of the tank, from which point the residual oil may be conveyed via a pipe to a heating tank, where this oil, together with the waste oil from the first tank, already approx. 80% cleaned, can be heated to approx. 90° C. before the oil is fed to a subsequent collection tank, and a filter connected to it for final cleaning of the separated oil and for feeding it to a tank before re-use, and in that both separation tanks incorporate sensors for keeping the water level in the tanks constant at all times.

4. A device according to claim 3, wherein the clean water fed in is adjustable by means of a second valve for feeding into the water filter for keeping it full, and by means of a first valve for feeding into the waste oil for regulating its temperature.
